(19) United States
(12) Patent Application Publication
(10) Pub. No.: US 2006/0182929 A1
(43) Pub. Date: Aug. 17, 2006

(54) Device comprising a micro-rough coating

(75) Inventors: Frank Joerdens, Traunstein (DE); Jurgen Salomon, Trostberg (DE); Gerhard Schmidmayer, Bad Endorf (DE); Bernhard Walter, Bernstadt (DE)

Correspondence Address: JOHN T. WINBURN, 100 BOSCH BOULEVARD, NEW BERN, NC, 28562, US

(73) Assignee: BSH Bosch und Siemens Hausgerate GmbH, Munich (DE)

(21) Appl. No.: 10/546,054

(22) PCT Filed: Feb. 17, 2004
(86) PCT No.: PCT/EP04/01493

§ 371 Date: Jan. 10, 2006

(30) Foreign Application Priority Data
Feb. 17, 2003 (DE) 103 06 582.2

(51) Int. Cl. G11B 5/64

(52) U.S. Cl. 428/141

(57) ABSTRACT

A cooking appliance having a cooking space with a micro-rough surface. The micro-rough surface is formed on a metal substrate. In order to better clean the micro-rough surface from dried or charred food material, the layer includes an enamel formed of a glass flux with separate crystal zones spaced from one another formed and embedded in the enamel. The crystal zones are formed by crystallizing portions of the enamel into crystalline phases, forming a rough superstructure with a plurality of fine structures on the surface of the superstructures.

The invention starts from a device with a micro-rough coating according to the preamble of claim 1.

Surfaces in the kitchen area, especially in cookers, become dirty through use and must be cleaned. Particularly stubborn dirt comprises burned-on food, especially fatty, oily, acid-containing or starch-containing substances which thermally degrade at temperatures between 200° C. and 250° C., become varnish-like or carbonise and result in very strongly adhering, carbonised residue or thin varnish films on the surface which can only be removed with great effort.

In order to solve this problem, surfaces liable to become dirty are usually embodied as enamel surfaces having good chemical resistance. The good chemical resistance counteracts any chemical roughening of the surface so that the dirt adheres less firmly. However, adhesion and burning-on is only counteracted unsatisfactorily so that mechanical cleaning using abrasive cleaning agents such as stainless steel wire pads or a glass scraper further requires great effort. Catalytically active enamels with rough, open-pored surfaces are also known. Oily and fat-containing contaminants are spread in the structure in the form of splashes and are catalytically degraded. However, inorganic residues such as salts remain and these can only be removed from the structure with difficulty. The effect decreases with time as a result of adulteration of the structure. Large-volume contaminants such as can occur as a result of food spilling over or running out cannot be degraded. Thus, the bottom surface in cookers is not usually provided with this type of surface.

DE 199 33 550 C2 further discloses a self-cleaning surface for a cooker with a micro-rough coating which exhibits a self-cleaning effect, the so-called lotus effect, as a result of its surface structure. In order to intensify the self-cleaning effect the surface is coated with a catalytically active metal. A micro-rough layer on a substrate is further known from DE 100 16 485 where the roughness is produced by the incorporation of structure-forming particles. The self-cleaning property of this surface can be enhanced by an additional coating of a hydrophobising agent.

The object of the invention is to further develop a generic device and especially with regard to the good cleaning properties and good mechanical stability of the micro-rough surface.

The object is solved according to the invention by the features of claim 1. Advantageous embodiments and further developments of the invention can be deduced from the dependent claims.

The invention starts from a device, especially a cooking appliance provided with a cooking space, comprising a substrate on which a layer having a micro-rough surface is arranged. It is proposed that the layer is an enamel layer with crystal zones that are embedded in a glass flux and comprise a crystalline phase crystallised out of the enamel, where crystal zones form a fine structure and a coarse superstructure on the surface of the layer.

As a result of crystal structures being crystallised out from the enamel in the crystal zones, these crystal structures are particularly firmly joined to the surrounding glass flux. Even when these crystal zones project far from an average surface, any breaking out of these crystal zones, for example, by violent scrubbing with a hard object, is effectively counteracted. The surface is thus particularly mechanically stable and resistant to abrasion, whereby a long lifetime is achieved without substantially impairing the properties of the surface. The fine structure and the superstructure are two structures considered separately, which are in communication with each other in the same way as trees (fine structure) on hills (superstructure).

The crystalline phase has crystals with a long-range order which form more than 90 weight percent of the crystal zones. Transition zones comprising a mixture of a crystalline phase and a glassy phase can be arranged around the crystal zones. Such a transition zone can form a continuous transition from the crystal zone into a region with predominantly glass flux. As a result of this continuous transition, the crystal zones are embedded particularly firmly in the glass flux. The crystals are formed by crystallisation of oxide phases out from the enamel. This crystallising out can be achieved by separation of substances in the enamel at the stoving temperature. The crystallising out can also be achieved by precipitation crystallisation. In this case, some solubility of the substances in the enamel exists at high temperatures and at least partial insolubility at low temperatures. In such a highly saturated enamel melt crystalline precipitates can be produced by the cooling process. The production of this type of enamel has been known for some time from the textbooks, e.g. from Armin Patzold, Helmut Fröschmann: “Enamel and enamelling technology”, Springer Verlag, Berlin 1987, Chapter 5.3 and Chapter 22.6. The crystalline phase can be composed of one or more of the substances TiO₂, CeO₂ or cerium silicate. However, compounds which also seem suitable to the person skilled in the art are also feasible.

In one embodiment of the invention, the crystal zones comprise larger first crystal zones and smaller second crystal zones which merely form a fine structure at the surface in regions between first crystal zones. The second crystal zones are smaller than the first crystal zones and create a roughness which counteracts the settling of food constituents in the otherwise predominantly smooth regions around the first crystal zones.

More appropriately, the fine structure forms elevations with interposed valleys, where the average shape of the elevations is more convexly defined than the average shape of the valleys is concavely defined. This structure is particularly water-repellent and the barely concave shape of the valleys counteracts any blockage of the valleys, for example by firmly adhering or burned-on residue. The elevations form convex formations whereas the areas around the elevations are embodied as flat or sloping, according to the location inside the superstructure, or in the case of closely adjacent elevations, as slightly concave. Undesirable substances which have been sprayed in thus find little foothold between the elevations.

The superstructure advantageously has an average profile height of 10 μm to 50 μm, especially of 10 μm to 30 μm, and the fine structure has an average profile height of 0.1 μm to 5 μm, especially of 0.5 μm to 3 μm. The surface is thus sufficiently anti-adhesive to ensure a sufficient dripping-off effect of liquids from the surface and sprayed-in fat-, oil- or starch-containing substances can easily be removed.

A good compromise between good hydrophobic properties and only loose adhesion of food constituents is achieved if the superstructure has a ratio of average profile height to average distance between neighbouring profile peaks of 0.1 to 3. With such a structural density inside the superstructure, the fine structure is also especially advantageously configured in a ratio of average profile height to average distance between neighbouring profile peaks of 0.3 to 10 in a fashion such that this compromise can be achieved especially well.

In a further embodiment of the invention, a dirt-repellent further layer with an anti-adhesive agent, especially a hydrophobising agent, is applied to the layer. Such a layer supports the anti-adhesive properties of the micro-rough surface without the surface needing to be enlarged, whereby easy solubility of the sprayed-in food residue would possibly be counteracted. A [sol gel], especially a siloxane is appropriately applied as anti-adhesive agent. Coating the micro-rough surface with such an anti-adhesive medium results in a significantly greater reduction in the wettability with liquids. The surface has a significantly improved cleaning property. The anti-adhesive medium can be applied by dipping, aerosol spraying, spraying, or rubbing in and is preferably stoved into the enamel layer at temperatures between 250° C. and 350° C.

A further advantage is achieved by applying the hydrophobising agent more thickly in the valleys of the fine structure than at the peaks of the fine structure. By this means the further layer is removed particularly little during mechanical treatment of the surface. The anti-adhesive agent is also protected in the valleys whereby good anchoring of the anti-adhesive agent on the surface is achieved.

Advantageously, the hydrophobising agent is between 0.1 μm and 2.5 μm thick in the valleys of the fine structure and is between 5 nm and 0.5 μm thick at the peaks of the fine structure. Particularly good resistance to abrasion is thereby achieved with good hydrophobic properties of the micro-rough structure at the same time.

In a further embodiment of the invention, the thickness of the hydrophobising agent in the valleys of the fine structure is between 25% and 75% of the average profile height of the fine structure. The wider the valleys of the fine structure are filled with the anti-adhesive agent, the less food residue can be retained in the valleys and burn on therein. If the degree of filling of the valleys is too high however, the micro-roughness of the surface is reduced to such an extent that the cleaning properties of the surface are reduced to an unsatisfactory extent. If the degree of filling is between 25% and 75%, clogging of food residue in the valleys is effectively counteracted whilst the cleaning properties of the micro-rough surface are good.

Depending on the adjustment of the viscosity of the anti-adhesive agent, this stays more at the peaks or more in the valleys of the fine structure when an anti-adhesive agent is rubbed into the micro-rough surface for example. When the viscosity is low, more anti-adhesive agent is deposited in the valleys. The micro-rough surface can hereby be very easily coated with the anti-adhesive agent by rubbing in. A freshening or regeneration of the further layer can also be carried out as part of a usual cleaning or care programme. In cases of severe contamination, staining or damage, the layer can be removed by simple means, such as oven sprays for example. A new coating is then applied, for example, by rubbing in and thus the initial state and initial effect are completely restored.

Further advantages are obtained from the following description of the drawings. The drawings show an exemplary embodiment of the invention. The drawings, the description and the claims contain numerous features in combination. The person skilled in the art will appropriately also consider the features individually and combine them to form logical further combinations.

In the figures:

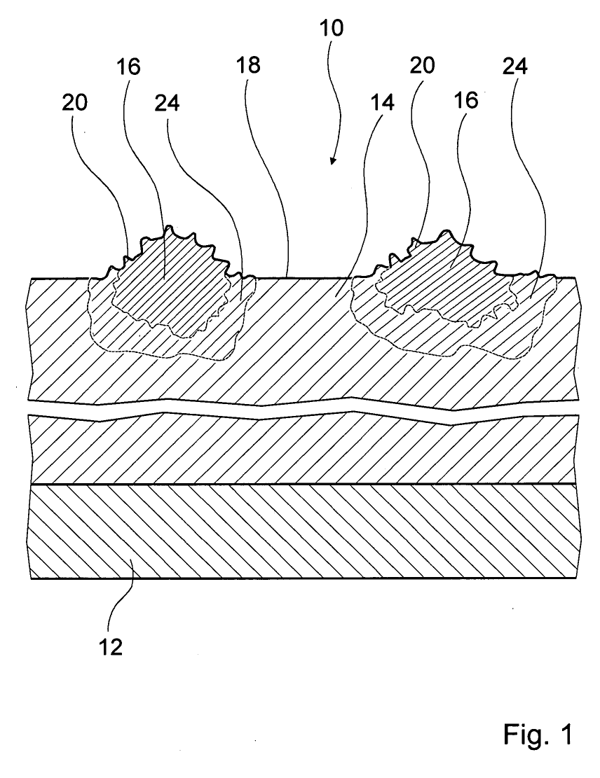

FIG. 1 is a section though an enamel layer with embedded crystal zones,

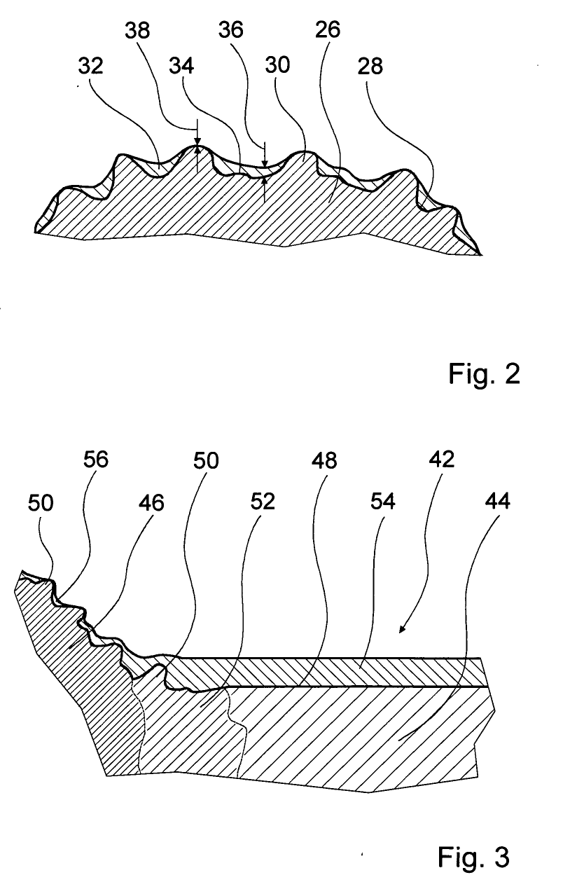

FIG. 2 is a section through a part of a crystal zone,

FIG. 3 is a section through an anti-adhesive layer on the enamel layer and

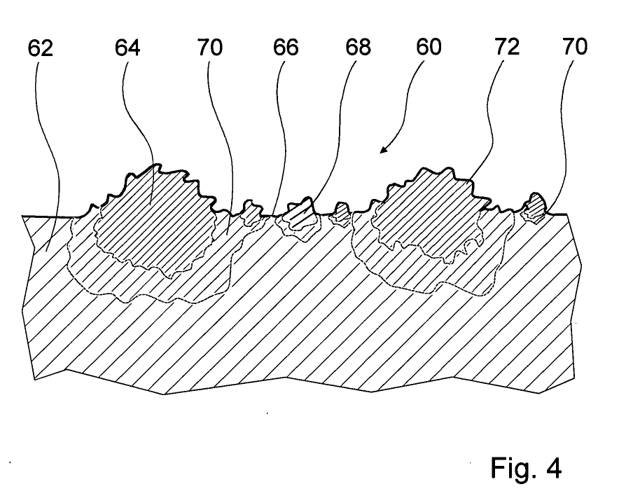

FIG. 4 is a section through a further enamel layer with crystal zones.

FIG. 1 shows an enamel layer 10 on a metal substrate 12. The enamel layer 10 and the substrate 12 are part of the wall of a cooking compartment of a cooker. The enamel layer 10 has a glass flux 14 with embedded crystal zones 16, which consist of a crystalline phase which has crystallised out from the enamel. FIG. 1 shows two crystal zones 16 arranged on the surface 18 of the enamel layer 10. The enamel layer 10 comprises further crystal zones which are not shown, which are arranged underneath the surface 18. The crystal zones 16 each form a “hill” which creates a coarse superstructure on the surface 18 as well as small formations 20 which form a fine structure at the locations where the crystal zones 16 project as “hills” from the surface 18. The crystal zones 16 thus form a fine structure and a coarse superstructure on the surface 18 of the enamel layer 10 where the fine structure is only configured in the area of the crystal zones 16. The valleys between the crystal zones 16 are substantially free from the fine structure. The hilly elevations of the crystal zones 16 above the average surface are convexly defined. The valleys lying between the elevations are largely flat and in any case less concavely defined that the elevations are convexly defined.

The crystal zones 16 are formed of a crystalline phase with crystals having long-range order at the atomic level. Inside the enamel layer 10 the crystal zones 16 are embedded in the glass flux 14 wherein a transition is revealed between the areas of the glass flux 14 and the crystal zones 16 which is shown schematically in FIG. 1 in the form of a transition region 24. In the vicinity of the crystal zones 16 the transition region 24 has a crystalline phase and in the vicinity of the glass flux 14 it tends to have an amorphous phase. From the macroscopic point of view, there is thus a continuous transition between the crystalline phase of the crystal zones 16 and the amorphous phase of the glass flux 14.

The average profile height of the elevations of the crystal zones 16 above the valleys is 25 μm. The average profile height of the formations 20 relative to the small valleys located between the formations 20 is 2 μm. The ratio of the average profile height to the average distance between neighbouring profile peaks of the elevations is 0.2. With reference to the fine structure, the ratio of the average profile height to the average distance between the neighbouring profile peaks of the formations 20 is 0.7.

FIG. 2 shows a section from a crystal zone 26 with formations 30 forming a fine structure. The surface 28 of the crystal zone 26 is coated with an anti-adhesive agent embodied as a hydrophobising agent 32. The hydrophobising agent 32 is a sol gel, and specifically a siloxane. The hydrophobising agent 32 is applied more thickly in the valleys 34 between the formations 30 of the fine structure than at the peaks of the fine structure. The average thickness of the hydrophobising agent 32 in the valleys is 1 μm whereas the average thickness 38 of the hydrophobising agent 30 at the peaks of the formations 28 is 50 nm. Since the average profile height of the formations 30 is 2 μm, approximately half the depth of the valleys 34 is filled by the hydrophobising agent 32. The average profile height of the fine structure including the hydrophobising agent 32 is thus reduced by half, that is to 1 μm, by the hydrophobising agent.

FIG. 3 shows a section from an enamel layer 42 at a location of the transition between a glass flux 44 and a crystal zone 46. Formations 50 forming a fine structure are revealed on the surface 48 of the enamel layer 42 both in the area of the crystal zone 46 and also in the area of the transition region 52 shown schematically where a partially crystalline phase is present. The surface 48 of the enamel layer 42 is coated with a hydrophobising agent 54 which is located both in the area of the crystal zone 46 and in the area of the glass flux 44. The hydrophobising agent 54 has a thickness of about 0.3 μm in the area of the valleys 56 between the formations 50 and is applied to a thickness of about 2 μm in the area of the surface 48 of the glass flux 44, that is in the valleys between the crystal zones 46. The valleys are hereby protected especially effectively against the adhesion of food residue.

Another embodiment of an enamel layer 60 with a matrix of glass flux 62 in which first crystal zones 64 are embedded is shown in FIG. 4. Between the first crystal zones 64 forming the superstructure can also be seen smaller second crystal zones 68 which form a fine structure on the surface 66 of the valleys. The fine structure on the surface 66 of the enamel layer 60 is thus formed by the formations 72 on the crystal zones 64 and the crystal zones 68 together whereas the crystal zones 64 form the coarse superstructure. In this case, the second crystal zones 68 form a coarser fine structure than the formations 72 on the first crystal zones 64. The second crystal zones 68 substantially consist of a cerium oxide or cerium silicate whereas the first crystal zones 64 are substantially formed from TiO₂. The size of the crystal zones 64, 68 is determined by the matrix composition of the enamel frit and by the melting and cooling temperature of the enamel frit or the enamel layer 60. The temperatures can be freely selected within limits predetermined by the materials and can thus be selected so that the desired crystal size, shape and density is achieved within the glass flux 62. Transition zones 70 shown schematically are again revealed between the crystal zones 64, 68 and the zones of the glass flux 62. Inside the enamel layer 60 further crystal zones 64, 68 are formed underneath the surface 66 but these are not shown in the figure for the sake of clarity.

1-10. (canceled)

11. A cooking appliance including a cooking space, the cooking space including a plurality of walls, comprising:
a substrate on at least one of the plurality of walls in the cooking space;
a micro-rough surface layer formed on said substrate; said surface layer being an enamel layer with a plurality of separate crystal zones embedded in a glass flux forming said enamel layer;
said crystal zones formed from a crystalline phase crystallized out of said enamel; and
said crystal zones including a fine structure and a coarse superstructure on the surface of said enamel layer.

12. The cooking appliance according to claim 11, including said crystal zones including larger first crystal zones and smaller second crystal zones, said smaller second crystal zones form a fine structure at said enamel layer surface in regions between said first crystal zones.

13. The cooking appliance according to claim 11, including said superstructure has an average profile height of substantially in the range of ten (10) microns (μm) to fifty (50) microns (μm) and said fine structure has an average profile height of substantially one tenth (0.1) microns (μm) to five (5) microns (μm).

14. The cooking appliance according to claim 13, including said superstructure has an average profile height of substantially in the range of ten (10) microns (μm) to thirty (30) microns (μm) and said fine structure has an average profile height of substantially five tenths (0.5) microns (μm) to three (3) microns (μm).

15. The cooking appliance according to claim 13, including said superstructure has a ratio of average profile height to average distance between neighboring ones of said profile peaks substantially in the range of one tenth (0.1) to three (3).

16. The cooking appliance according to claim 13, including said fine structure has a ratio of average profile height to average distance between neighboring ones of said profile peaks substantially in the range of three tenths (0.3) to ten (10).

17. The cooking appliance according to claim 13, including a dirt-repellent layer with an anti-adhesive agent formed on said enamel layer.

18. The cooking appliance according to claim 17, including said anti-adhesive agent is a hydrophobising agent.

19. The cooking appliance according to claim 18, including said hydrophobising agent is a sol gel especially a siloxane.

20. The cooking appliance according to claim 19, including said sol gel is a siloxane.

21. The cooking appliance according to claim 18, including said fine structure is formed with a plurality of peaks with valleys therebetween and said hydrophobising agent layer is thicker in said valleys of said fine structure than on said peaks of said fine structure.

22. The cooking appliance according to claim 21, including said hydrophobising agent is substantially in the range of between one tenth (0.1) microns (μm) and two and one-half (2.5) microns (μm) thick in said valleys of said fine structure and is substantially in the range of between five (5) nanometers (nm) and five hundred (500) nanometers (nm) thick at said peaks of said fine structure.

23. The cooking appliance according to claim 21, including said thickness of said hydrophobising agent in said valleys of said fine structure is substantially in the range of between twenty-five (25) percent (%) and seventy-five (75) percent (%) of the average profile height of said fine structure.
